(19) United States
(12) Patent Application Publication
(10) Pub. No.: US 2010/0034472 A1
(43) Pub. Date: Feb. 11, 2010

(54) PROCESSING APPARATUS AND METHODS FOR IMAGE QUALITY

(75) Inventor: Chien-Tang Tseng, Taipei Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ACER INCORPORATED, Taipei Hsien (TW)

(21) Appl. No.: 12/260,146

(22) Filed: Oct. 29, 2008

(30) Foreign Application Priority Data
Aug. 11, 2008 (TW) 97130513

(51) Int. Cl. G06K 9/36

(52) U.S. Cl. 382/232

(57) ABSTRACT

An image quality processing apparatus is disclosed. The apparatus includes an image module, a bandwidth detection module, an image control module, an image compression module and an image-outputting module. The image module receives an image. The bandwidth detection module detects a bandwidth of the internet. The image control module is coupled to the image module and the bandwidth detection module, determines the range of the bandwidth and issues a result according to the determined range. The image compression module compresses the image according to the result and generates a compressed image. The image-outputting module outputs the compressed image to the internet.

This Application claims priority of Taiwan Patent Application No. 97130513, filed on Aug. 11, 2008, the entirety of which is incorporated by reference herein.

### BACKGROUND OF THE INVENTION

1. Field of the Invention

The invention relates generally to an image quality processing apparatus, and more particularly, to an image quality processing apparatus for real-time processing of internet images.

2. Description of the Related Art

Driven by the development of the internet, a great deal of internet-related applications has been introduced, such as on-line video programs and video conferences. In general, video-related applications require much greater bandwidth than other types of application to maintain stable image quality. For instance, many on-line programs or video conferences require bandwidth of around 350K to 400K in order to maintain stable image quality. However, internet bandwidth is often variable and affected by a plurality of factors. For example, internet bandwidth is affected by the amount of users accessing the internet. Thus, the more users that access the internet through one bandwidth, the more the bandwidth is limited. Additionally, the type and size of files being downloaded or uploaded through the internet, affects available bandwidth. For example, larger files downloaded or uploaded from the internet causes greater limiting of the internet bandwidth utilized thereof. Therefore, image quality for users accessing the internet is directly affected by available bandwidth.

### BRIEF SUMMARY OF THE INVENTION

In light of the previously described problems, the invention discloses an image quality processing apparatus, processing an image and transmitting the image through the internet. The image quality processing apparatus comprises an image module, a bandwidth detection module, an image control module, an image compression module and an image-outputting module. The image module receives an image. The bandwidth detection module detects a bandwidth of the internet. The image control module is coupled to the image module and the bandwidth detection module, determines the range of the bandwidth and issues a result according to the determined range. The image compression module compresses the image according to the result and generates a compressed image. The image-outputting module outputs the compressed image to the internet.

Furthermore, the invention discloses an image quality processing method, processing an image and transmitting the image through the internet. The method comprises receiving an image, detecting a bandwidth of the internet, determining the range of the bandwidth, compressing the image according to the determined range of the bandwidth and generating a compressed image, and outputting the compressed image to the internet.

### BRIEF DESCRIPTION OF THE DRAWINGS

The invention can be more fully understood by reading the subsequent detailed description and examples with references made to the accompanying drawings, wherein:

FIG. 1 depicts a block diagram of an embodiment of an image quality processing apparatus 10;

FIG. 2 depicts a configuration of the image IMG;

FIG. 3 depicts another configuration of the image IMG;

FIG. 4 depicts yet another configuration of the image IMG; and

FIG. 5 depicts a flowchart of an embodiment of an image quality processing method according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

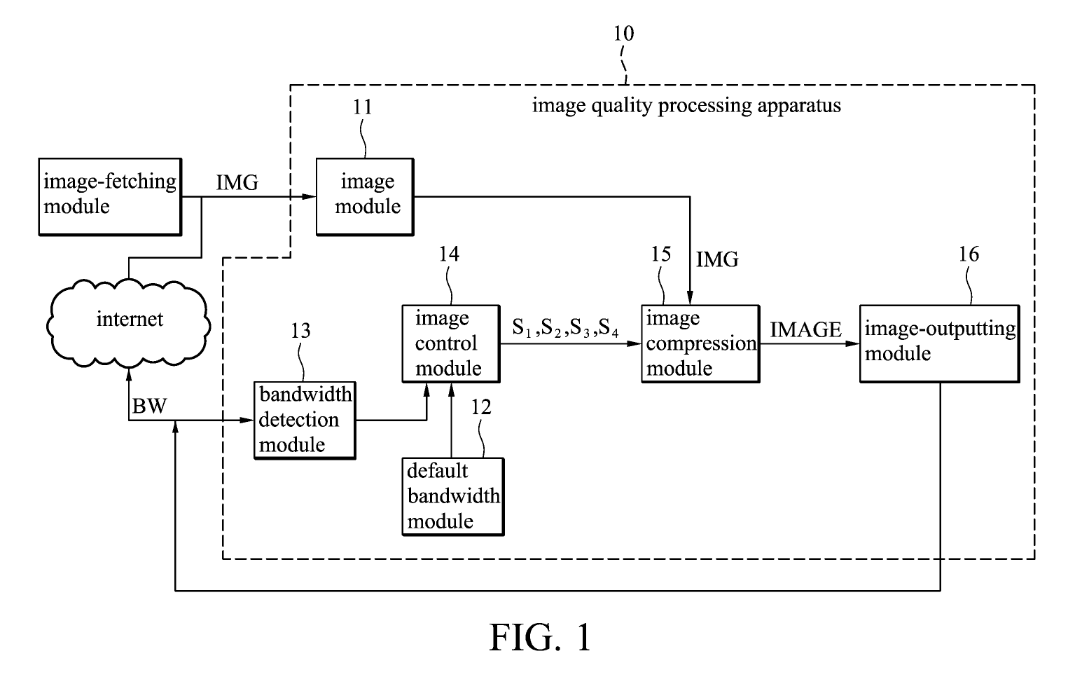

FIG. 1 depicts a block diagram of an embodiment of an image quality processing apparatus 10. The image quality processing apparatus 10 comprises an image module 11, a default bandwidth module 12, a bandwidth detection module 13, an image control module 14, an image compression module 15 and an image-outputting module 16.

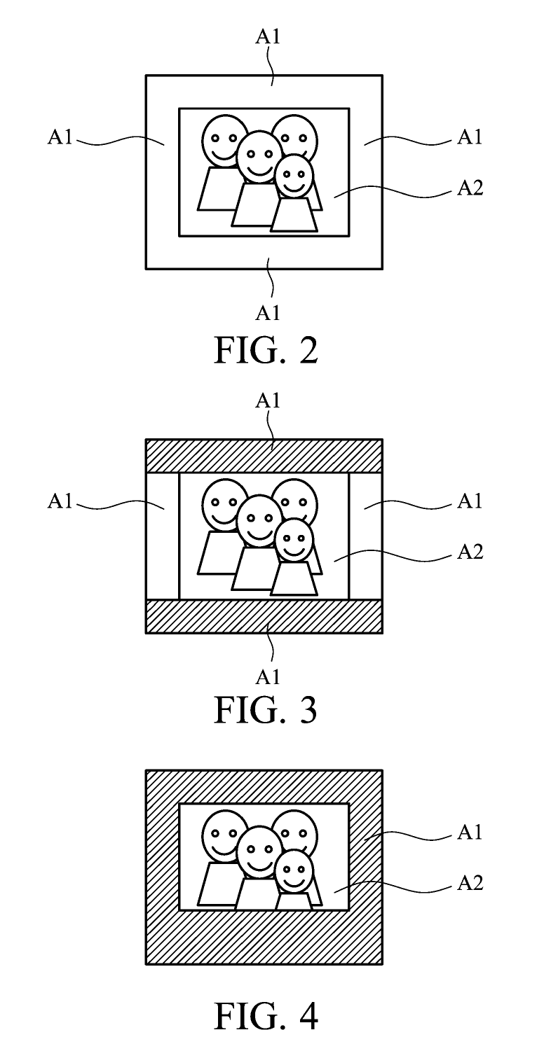

The image module 11 is electrically connected to an image-fetching module or internet for receiving an image IMG. The image IMG comprises a first area A1 and a second area A2. As shown in FIG. 2, the first area A1 is the outer part of the image IMG and the second area A2 is the central part of the image IMG. The default bandwidth module 12 is used to set a default bandwidth which namely represents the bandwidth required for maintaining a stable image quality. For instance, if the bandwidth required to play the video images online without any lag is 350K, then the default bandwidth module 12 sets the default bandwidth as 350K. The bandwidth detection module 13 is also electrically connected to the internet and detects the bandwidth BW of the internet. The image control module 14 is electrically connected to the default bandwidth module 12 and the bandwidth detection module 13. The image control module 14 is used to determine the range of the bandwidth BW detected by the bandwidth detection module 13 and issues a first result S1 according to the determined range of the bandwidth BW. For example, if the bandwidth detection module 13 detects that the bandwidth BW of the internet is 400K (as a non-limiting example), then the image control module 14 determines that the bandwidth BW (400K) of the internet is indeed higher than the bandwidth of 350K required for maintaining a stable image quality. Then, the image control module 14 issues a first result S1 to the image compression module 15 for instructions to compress the image IMG with a predetermined compression quality. Next, the image compression module 15 compresses the image IMG (both first area A1 and second area A2) with the predetermined compression quality according to the first result S1 and generates a compressed image IMAGE. Finally, the image-outputting module 16 outputs the compressed image IMAGE to the internet. It is noted that the bandwidth BW of the internet detected by the bandwidth detection module 13 is the actual available bandwidth between the image quality processing apparatus 10 and the recipient (terminal user) of the image IMG.

In another case, the bandwidth BW of the internet detected by the bandwidth detection module 13 might be lower than 350K, i.e. 310K, for example. In this example, the image control module 14 determines that the bandwidth BW (310K) of the internet falls within a first bandwidth range, say, from 300K to 350K. Because the first bandwidth range (300K to 350K) is merely a little bit lower than the 350K required for maintaining a stable image quality, the image control module 14 issues a second result S2 to the image compression module 15 for instructions to perform the following: (1) compress the data corresponding to the second area A2 (central part) of the image IMG with a predetermined compression quality, and (2) compress the data corresponding to the first area A1 (outer part) of the image IMG with a compression quality lower than the predetermined compression quality. Because the detected bandwidth BW (310K) of the internet is just somewhat lower than the bandwidth (350K) required for maintaining the stable image quality, the strategy in this case is to maintain good compression quality for the more important parts of the image IMG by sacrificing compression quality for the more less important parts of the image IMG (usually, the less important part of an image would be the outer part). Finally, the image compression module 15 generates a compressed image IMAGE which is further output to the internet by the image-outputting module 16.

The non-limiting embodiment previously described discloses that the bandwidth BW of the internet is detected to be 310K. However, the bandwidth BW of the internet detected by the bandwidth detection module 13 might be even lower, i.e. 280K, for example. In this embodiment, the image control module 14 determines that the bandwidth BW (280K) of the internet falls within a second bandwidth range, say, from 250K to 300K. Since the second bandwidth range (250K to 300K) is lower than 350K by a certain amount, the image control module 14 issues a third result S3 to the image compression module 15 for instructions to perform the following: (1) compress the data corresponding to the second area A2 (central part) of the image IMG with a predetermined compression quality, (2) compress the data corresponding to a part of the first area A1 (outer part) of the image IMG with a compression quality lower than the predetermined compression quality, and (3) dump the data corresponding to another part of the first area A1. As shown in FIG. 3, the data corresponding to the second area A2 is compressed with the predetermined compression quality, the data corresponding to the left and right parts of the first area A1 is compressed with a compression quality lower than the predetermined compression quality, and the data corresponding to the upper and lower parts of the first area A1 is dumped. In contrast to the previous embodiment, the dumped data in this embodiment was originally compressed with a compression quality in previous embodiment. Thus, data is dumped so that less bandwidth resources are occupied, thereby ensuring the image quality of the important parts of the image IMG. With the above method, the image quality of important parts of the image IMG can still be maintained even if internet bandwidth is constrained.

It should be noted that, in the above embodiment, even though the data corresponding to the upper and lower parts of the first area A1 is dumped, any corresponding parts of data in the first area A1 may be dumped.

The non-limiting embodiment previously described discloses that the bandwidth BW of the internet is detected to be 280K. However, the bandwidth BW of the internet detected by the bandwidth detection module 13 might be even lower than 280K, such as 220K, for example. In this embodiment, the image control module 14 determines that the bandwidth BW (220K) of the internet falls within a third bandwidth range, say, from 200K to 250K. Because the third bandwidth range (200K to 250K) is much lower than 350K, the image control module 14 issues a fourth result S4 to the image compression module 15 for instructions to perform the following: (1) compress the data corresponding to the second area A2 (central part) of the image IMG with a predetermined compression quality, and (2) dump all of the data corresponding to the first area A1 (outer part) of the image IMG, as shown in FIG. 4. In this manner, more bandwidth resources are saved since all of the data corresponding to the first area A1 of the image IMG is dumped, thereby ensuring the image quality of the important parts of the image IMG.

Above embodiments disclose different strategies for dealing with different cases where different bandwidths are detected. Although the first area A1 and the second area A2 in the above embodiments are disclosed to be respectively the outer and inner parts of the image IMG, they may still be other parts of the image IMG (say left and right parts) different from each other. In addition, in the second embodiment where the bandwidth BW of the internet is detected to be 280K, even though the data corresponding to the upper and lower parts of the first area A1 is dumped by the image compression module 15, the data to be dumped is not necessarily limited to the upper and lower parts, meaning that it can be any part of the first area A1.

Furthermore, although the data corresponding to the important part (the second area A2) of the image IMG is compressed with a predetermined compression quality in the above embodiment, a compression quality higher than the predetermined compression quality can also be used if necessary. Therefore, the concept of the invention is not only restricted to compressing the data corresponding to a certain part of the image with a predetermined compression quality, or dumping the data corresponding to a certain part of the image, but also increasing the compression quality of the image.

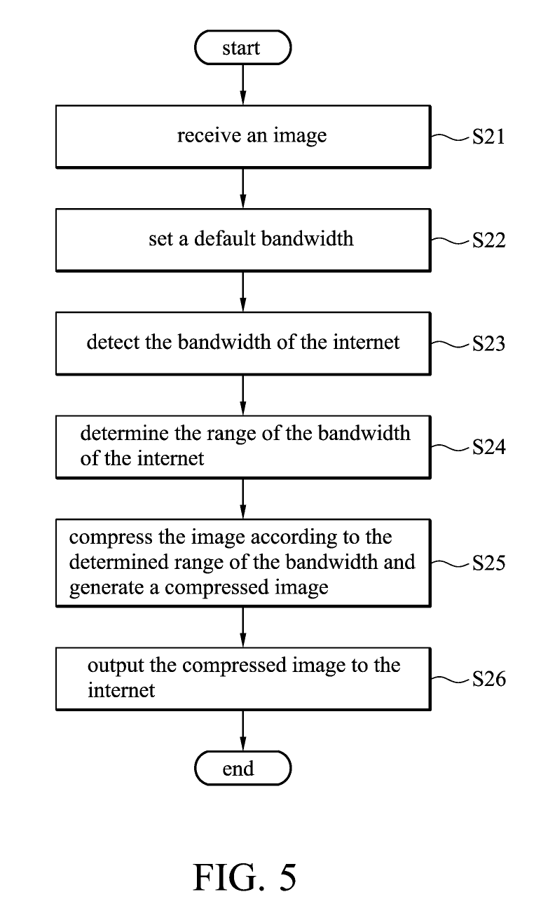

FIG. 5 depicts a flowchart of an embodiment of an image quality processing method according to the invention, handling an image received from the internet. In the step S21, an image is received. The image comprises a first area A1 and a second area A2, wherein the first area A1 is the outer part of the image and the second area A2 is the central part of the image. In the step S22, a default bandwidth is set. In this step, the purpose is to set a bandwidth required for maintaining a stable image quality, i.e. 350K, for example. In the step S23, the bandwidth of the internet is detected. It is noted that the bandwidth detected in step S23 refers to the actual available bandwidth between the image quality processing apparatus and the image recipient. In the step S24, the range of the bandwidth of the internet is determined. For example, it is determined whether the range of the bandwidth is within the first range from 300K to 350K, within the second range from 250K to 300K, or within the third range from 200K to 250K. In the step S25, the image according to the range of the bandwidth determined in step S24 is compressed, and then a compressed image is generated. If the bandwidth of the internet is determined to be higher than 350K (such as 400K, for example), this indicates that the bandwidth of the internet is sufficient for providing a good-quality image. Therefore, the data of the image (first area A1 plus second area A2) is compressed with a predetermined compression quality. On the other hand, if the bandwidth of the internet is determined to be within a first bandwidth range which is a little lower than 350K (such as 310K, for example), then the data corresponding to the second area A2 of the image is compressed with a predetermined compression quality, and the data corresponding to the first area A1 of the image is compressed with a compression quality lower than the predetermined compression quality. If the bandwidth of the internet is determined to be within a second bandwidth range (such as 280K, for example), then the data corresponding to the second area A2 of the image is compressed with a predetermined compression quality, the data corresponding to a part of the first area A1 of the image is compressed with a compression quality lower than the predetermined compression quality, and the data corresponding to another part of the first area A1 is dumped. If the bandwidth of the internet is determined to be within a third bandwidth range which is at a greater distance from 350K (such as 220K, for example), then the data corresponding to the second area A2 of the image is compressed with a predetermined compression quality, and the data corresponding to the first area A1 is dumped. Finally, the compressed image is output to the internet in step S26.

Finally, it is noted that the first, second and third bandwidth ranges are determined according to the default bandwidth. Each bandwidth range is indicative of the distance between the internet bandwidth and the default bandwidth required for maintaining a stable image quality. Therefore, the invention employs different compression strategies depending upon the internet bandwidth range.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image quality processing apparatus, comprising:
an image module receiving an image, wherein the image comprises a first area and a second area, and the first area is the outer part of the image and the second area is the central part of the image;
a bandwidth detection module detecting a bandwidth of the internet;
an image control module coupled to the image module and the bandwidth detection module, wherein the image control module determines the range of the bandwidth and issues a result according to the determined range;
an image compression module compressing the image according to the result and generating a compressed image; and
an image-outputting module outputting the compressed image to the internet.

2. The image quality processing apparatus as claimed in claim 1, wherein the image is received from an image-fetching module or the internet.

3. The image quality processing apparatus as claimed in claim 1, wherein the image control module issues the result when the bandwidth of the internet is within a predetermined bandwidth range.

4. The image quality processing apparatus as claimed in claim 3, wherein the image compression module performs the following procedures according to the result:
compressing the data corresponding to the second area of the image with a predetermined compression quality; and
compressing the data corresponding to the first area of the image with a compression quality lower than the predetermined compression quality.

5. The image quality processing apparatus as claimed in claim 3, wherein the image compression module performs the following procedures according to the result:
compressing the data corresponding to the second area of the image with a predetermined compression quality; and
dumping the data corresponding to the first area of the image.

6. The image quality processing apparatus as claimed in claim 3, further comprising a default bandwidth module setting a default bandwidth, wherein the predetermined bandwidth range is determined according to the default bandwidth.

7. An image quality processing method, comprising:
receiving an image, wherein the image comprises a first area and a second area, and the first area is the outer part of the image and the second area is the central part of the image;
detecting a bandwidth of the internet;
determining the range of the bandwidth;
compressing the image according to the determined range of the bandwidth and generating a compressed image; and
outputting the compressed image to the internet.

8. The image quality processing method as claimed in claim 7, further comprising receiving the image from an image-fetching module or the internet.

9. The image quality processing method as claimed in claim 7, further comprising performing the following procedures when the bandwidth of the internet is within a predetermined bandwidth range:
compressing the data corresponding to the second area of the image with a predetermined compression quality; and
compressing the data corresponding to the first area of the image with a compression quality lower than the predetermined compression quality.

10. The image quality processing method as claimed in claim 7, further comprising performing the following procedures when the bandwidth of the internet is within a predetermined bandwidth range:
compressing the data corresponding to the second area of the image with a predetermined compression quality; and
dumping the data corresponding to the first area of the image.

11. The image quality processing method as claimed in claim 9, further comprising setting a default bandwidth and determining the predetermined bandwidth range according to the default bandwidth.
